(19) United States
(12) Patent Application Publication
(10) Pub. No.: US 2023/0013178 A1
(43) Pub. Date: Jan. 19, 2023

(54) FLOOR AND COLUMN STRUCTURE

(71) Applicant: Jianyou WANG, Wenzhou (CN)

(72) Inventor: Jianyou WANG, Wenzhou (CN)

(21) Appl. No.: 17/946,240

(22) Filed: Sep. 16, 2022

Related U.S. Application Data
(63) Continuation-in-part of application No. PCT/CN2021/077414, filed on Feb. 23, 2021.

(30) Foreign Application Priority Data
Mar. 23, 2020 (CN) 202010262420.2
Mar. 23, 2020 (CN) 202020493281.X

(51) Int. Cl. E04B 5/21; H02G 3/38; E04B 5/48

(52) U.S. Cl. CPC E04B 5/21; H02G 3/283; E04B 5/48

(57) ABSTRACT

A floor and column structure consists of floors and columns in a building, wherein each of the floors is composed of a floor iron sheet, square pipes, a floor steel grating, a lower impermeable membrane, rigid plastic foam, an upper impermeable membrane and cement stone concrete; each of the columns is composed of a column iron sheet, column steel gratings, steel posts and cement stone concrete; the floor iron sheet, the square pipes and the floor steel grating and the column iron sheets, the column steel gratings and the steel posts are welded into a framework; the lower impermeable membrane, the rigid plastic foam and the upper impermeable membrane are provided over the floor steel grating; Various pipelines are installed in the plastic foam layer; the cement stone concrete is provided over the upper impermeable membrane; and a colored cement talc layer is provided over the cement stone concrete. The inventive floors and columns do not need to be supported and reinforced by concrete beams, do not need to be enclosed by supporting timber boards during casting, can isolate vibration, insulate sound and heat, greatly shorten engineering time, prevent leakage, and facilitate pipeline installation, have smooth, bright, visually pleasant, sanitary and freshening surfaces, and can replace floors and columns in existing large buildings and be applied to the construction field.

### CROSS-REFERENCE TO RELATED APPLICATION

This application claims the benefit of priority of Chinese Patent Application No. 202010262420.2 filed to the Chinese Patent Office on Mar. 23, 2020, entitled “FLOOR AND COLUMN” and Chinese Patent Application No. 202020493281.X filed to the Chinese Patent Office on Mar. 23, 2020, entitled “FLOOR AND COLUMN,” the disclosure of which are incorporated herein by reference in their entirety.

### TECHNICAL FIELD

The present application relates to multi-layer structured floors and columns, in particular to a frame-type floor and column structure which does not need reinforced concrete beams, is capable of vibration isolation and acoustic and thermal insulation, can prevent leakage, has smooth, bright, visually pleasant, sanitary and freshening surfaces and can bear relatively large loads, and does not need supporting timber boards during construction.

### BACKGROUND

At present, building floors and columns are reinforced cement concrete floors and columns, which are formed by pouring and curing cement, stone slurry over and around steel gratings. \textcircled{1}Because the cement stone slurry will flow downwards and around during pouring, before pouring, lower and surrounding areas of the steel grating need to be enclosed or sealed with supporting timber boards to prevent outflow of the cement slurry, and after the cement stone slurry is completely solidified, the supporting timber boards need to be removed, thereby causing waste of a large amount of materials and man-hours, and a very long construction time. In addition, the reinforced cement concrete floor and column structure is simple. With a single row of steel grating for support, the floors and columns are not effectively welded, which cannot form an effective integrated frame, and cannot be stressed as a whole at the same time, which is not firm. Therefore, reinforced cement concrete beams for supporting and reinforcement are required under the floors, thereby causing waste of a large amount of materials and room space. \textcircled{2}The reinforced cement concrete floor has no effect of vibration isolation or, acoustic and thermal insulation. Vibration, sound and heat energy can be conducted across the floor. The sound of footsteps and the sound of toilets at night have a serious impact on sleep of people in downstairs rooms. The vibration of outdoor vehicles and roads will affect rooms in the building. After exposure to sunlight, the top floor room will become sultry, and the heat energy of an electric heating floor will spread downstairs, causing waste. \textcircled{3}A drain pipe from a hand washing basin, a dish washing basin, a washing machine, etc. and a sewage pipe from a toilet are connected in parallel under the floor, which has a great impact on the downstairs room, and repair is not convenient in case of pipeline leakage. \textcircled{4}The surface of reinforced cement concrete is uneven, poor in brightness, visually unpleasant, unsanitary and not freshening.

### SUMMARY

The purpose of this application is to solve the above problems of the floors and columns, by providing a floor and column structure which does not need reinforced concrete beams, is capable of vibration isolation and acoustic and thermal insulation, can prevent leakage, can greatly shorten the engineering time, has no influence on rooms by pipelines, has smooth, bright, visually pleasant, sanitary and freshening surfaces, and does not need supporting timber boards during construction.

In order to achieve this purpose, the present application adopts the following technical schemes:

The present application consists of floors and columns, wherein each of the floors is composed of a floor iron sheet, square pipes, a floor steel grating, a lower impermeable membrane, rigid plastic foam, an upper impermeable membrane and cement stone concrete; each of the columns is composed of a column iron sheet, column steel gratings, steel posts and cement stone concrete; the floor iron sheet is large and flat; the column iron sheet is shaped into a cylindrical column, a square column, or a column with rounded corners; the floor iron sheet is fixedly welded to the column iron sheet; an upper surface of the floor iron sheet is welded to a lower part of each of the square pipes; an upper part of each square pipe is welded to the floor steel grating; there are steel posts inside each of the columns; an upper part of the column is provided with a column steel grating; the floor steel grating is welded to the column steel posts and the column steel grating; the floor iron sheet, the square pipes and the floor steel grating and the column iron sheets, the column steel gratings and the steel posts are welded into a framework, which is an integrated architecture. A local stress on the floor will become an overall stress on the whole floor. The iron sheets, square pipes and steel gratings reinforce each other, and the floor is firm. Therefore, it is not necessary to reinforce the structure with reinforced concrete beams. In this way, a lot of materials and room space are saved, and even the space above the ceiling of the room may be omitted. Cement stone concrete slurry is used to be poured into the space around and below the steel gratings. Because the column iron sheet has encapsulated the column steel grating and the floor iron sheet has sealed the bottom of the floor steel grating, it is not necessary to use supporting timber boards during pouring, which also saves a lot of materials and labor hours. The lower impermeable membrane, the rigid plastic foam and the upper impermeable membrane are cuboid provided over the floor steel grating. The upper impermeable membrane, the rigid plastic foam and the lower impermeable membrane play a role of vibration isolation and acoustic and thermal insulation, which can prevent conduction of vibration, sound and heat between adjacent floors. In this way, the sound of walking at night is low, which does not affect the sleep of people downstairs. The vibration of external cars on the road has no influence on the rooms in the building. The top floor room will not be sultry when exposed to the sun. The heat energy generated by the electric heating floor will not diffuse downwards through the floor. The upper impermeable membrane and the lower impermeable membrane have an anti-seepage function and can prevent sewage in pipelines in the plastic foam layer from leaking vertically. A drain pipe from a bathroom, a hand washing basin, a dish washing basin, etc. and a sewage pipe from a toilet are connected in parallel in the plastic foam layer and then joined to a main pipe, which is arranged in a pipeline groove beside the column. A gas pipe, a heating pipe, an air conditioner pipe, a water pipe and various cables extend separately from the main pipe in the pipeline groove beside the column, pass through the plastic foam layer and enter a user meter box. The pipes and cables are arranged in the rigid plastic foam, and not concreted with the cement, which is convenient for installation and maintenance. The upper impermeable membrane can prevent the overlying cement slurry from flowing down. The cement stone concrete is provided over the upper impermeable membrane. The surface of cement stone concrete is treated separately.

Based on the technical scheme above, when the floor iron sheet (1) is thickened such that the floor iron sheet (1) can bear loads of the floor and objects on the floor, the square pipes (2) and the floor steel grating (3) are omitted.

Based on the technical scheme above, when the column iron sheet (11) is thickened such that the column iron sheet (11) and the steel posts (13) can support the overlying part of the building, the column steel grating (12) is omitted.

Based on the technical scheme above, when the column iron sheet (11) is thickened such that the column iron sheet (11) and the steel posts (13) can support the overlying part of the building, the column steel grating (12) and the cement stone concrete in the column are omitted.

Based on the technical scheme above, when the column iron sheet (11) is thickened, the column steel grating (12), the steel posts (13) and the cement stone concrete in the column are omitted.

Based on the technical scheme above, when the column iron sheet (11) is thickened such that the column iron sheet (11) can independently support the overlying part of the building, the column steel grating (12) and the steel posts (13) are omitted.

Based on the technical scheme above, according to specific actual situations, the lower impermeable membrane (4) is omitted.

Based on the technical scheme above, according to specific actual situations, the upper impermeable membrane (6) is omitted.

Based on the technical scheme above, according to specific actual situations, the rigid plastic foam (5) is replaced by hollow bricks with the same acoustic and thermal insulation and vibration isolation functions.

Based on the technical scheme above, according to specific actual situations, the rigid plastic foam (5) is replaced by a spaced supporting timber board layer with the same acoustic and thermal insulation and vibration isolation functions.

Based on the technical scheme above, if the floor panel is wooden floor, cement stone concrete (7) is omitted according to actual situations.

Further, the present application further provides a floor and column structure, consisting of floors and columns, wherein the floor includes a floor iron sheet (1) and a layer for acoustic and thermal insulation and vibration isolation provided over the iron sheet, the layer for acoustic and thermal insulation and vibration, isolation being rigid plastic foam (5), a hollow brick layer, or a spaced supporting timber board layer; and each of the columns includes a column iron sheet (11).

Optionally, in the floor and column structure, the floor further includes square pipes (2) provided over the floor iron sheet (1), and an upper surface of the floor iron sheet (1) is welded to a lower part of each of the square pipes (2).

Optionally, in the floor and column structure, each of the floors further includes a floor steel grating (3) provided over the square pipes (2), and an upper part of each square pipe (2) is welded to the floor steel grating (3).

Optionally, in the floor and column structure, each of the floors further includes a lower impermeable membrane (4) provided over the floor iron sheet (1).

Optionally, in the floor and column structure, the lower impermeable membrane (4) is provided over the floor steel grating (3).

Optionally, in the floor and column structure, each of the floors further includes an upper impermeable membrane (6), and the upper impermeable membrane is provided over the layer for acoustic and thermal insulation and vibration isolation.

Optionally, in the floor and column structure, each of the floors further includes cement stone concrete (7), and the cement stone concrete (7) is provided over the upper impermeable membrane (6).

Optionally, in the floor and column structure,

each of the floors is composed of the floor iron sheet (1), square pipes (2), a floor steel grating (3), the layer for acoustic and thermal insulation and vibration isolation, an upper impermeable membrane (6) and cement stone concrete (7) arranged in sequence; or

the floor is composed of the floor iron sheet (1), square pipes (2), a floor steel grating (3), a lower impermeable membrane (4), and the layer for acoustic and thermal insulation and vibration isolation arranged in sequence; or

when the floor iron sheet (1) is thickened such that the floor iron sheet (1) can bear loads of the floor and objects on the floor, the floor is composed of the floor iron sheet (1), a lower impermeable membrane (4), the layer for acoustic and thermal insulation and vibration isolation, an upper impermeable membrane (6) and cement stone concrete (7) arranged in sequence.

Optionally, in the floor and column structure, each of the columns further includes one or more of a column steel grating (12), a steel post (13) and cement stone concrete.

Optionally, as required by interior decoration, a ceiling is formed under the floor iron sheet, some of electric wires, network cables, telephone lines, closed circuit television lines, heating pipes, cooling pipes, water pipes and gas pipes extend above the ceiling, and some of the electric wires, network cables, telephone lines, closed circuit television lines, heating pipes, cooling pipes, water pipes, gas pipes and sewage pipes extend through the rigid plastic foam layer, namely, part of the electric wires, network cables, telephone lines, closed circuit television lines, heating pipes, cooling pipes, water pipes and gas pipes extend above the ceiling, and the rest of the electric wires, network cables, telephone lines, closed circuit television lines, heating pipes, cooling pipes, water pipes, gas pipes and sewage pipes extend through the rigid plastic foam layer.

Compared with the current reinforced concrete floors and columns, according to the present application, the steel posts are welded within the column, the iron sheet is welded around the column, the square pipes and the iron sheet are welded under the floor steel grating, the lower impermeable membrane, the rigid plastic foam, the upper impermeable membrane and various pipelines are arranged above the floor steel grating, and a colored cement talc layer is poured above the cement stone concrete, so that the following beneficial effects are achieved. \textcircled{1}The floor iron sheet, the square pipes and the floor steel grating are directly welded to the column iron sheets, the column steel gratings and the steel posts, forming an integrated framework, such that a local stress on the floor is transformed into an overall stress, and the stress area is greatly increased. The structure is very firm, so there is no need for reinforcement by reinforced concrete beams, the bottom of the floor becomes flat and visually pleasant, thus saving a lot of materials and room space, and the space above the ceiling of the room can be omitted. \textcircled{2}The lower part of the floor steel grating is connected to the iron sheet via the square pipes for bottom sealing. The column steel grating is enclosed by the column iron sheet. When the cement stone slurry is filled and poured, the cement slurry will not flow out. Therefore, there is no need to use the supporting timber boards, which also saves a lot of materials and labor hours and can greatly shorten the construction time. \textcircled{3}The upper impermeable membrane, the rigid plastic foam and the lower impermeable membrane are capable of vibration isolation and acoustic and thermal insulation, such that the vibration inside and outside the building will not be transmitted to the rooms in the building. The sound of walking at night is low, which does not affect the sleep of people downstairs. The top floor room will not be sultry when exposed to the sun. The heat energy generated, by the electric heating floor will not diffuse downwards through the floor. \textcircled{4}The upper impermeable membrane and the lower impermeable membrane can avoid the upward and downward leakage of pipes in the plastic foam layer. User pipelines are installed in the plastic foam layer, which has no influence on the rooms above and under the floor. The upper and lower surfaces of the rooms above and under the floor are sanitary and visually pleasant. The pipes and cables are not concreted with the cement, which is convenient for installation and maintenance. The upper impermeable membrane can prevent the overlying cement slurry from flowing into the plastic foam layer. \textcircled{5}A colored cement talc layer is provided over the cement stone concrete, and the surface of colored cement talc layer is flat, bright, visually pleasant, sanitary and freshening. \textcircled{6}Electric wires in a room under the floor extend from the meter box, run upwards through switches on walls, and extend between the floor iron sheet and steel grating. During installation, only slotting, wire placing, sealing and welding, and filling are needed, which is convenient for installation. At the same time, the influence of the electric wires and dust over the electric wires on the room is avoided.

### BRIEF DESCRIPTION OF DRAWINGS

FIG. 1 is a schematic view of a floor;

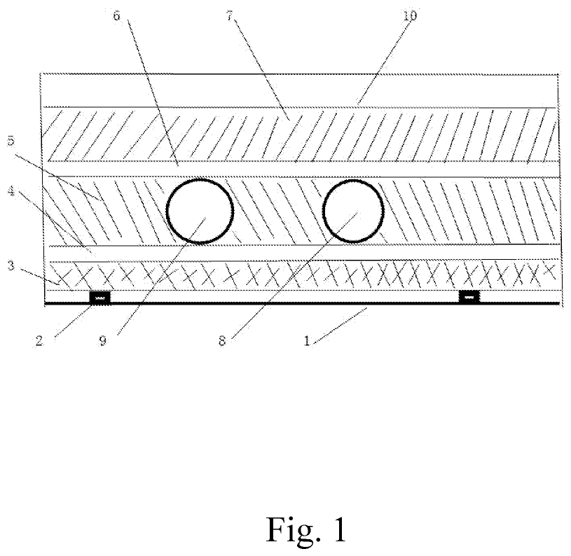

FIG. 2 is a schematic view of a column;

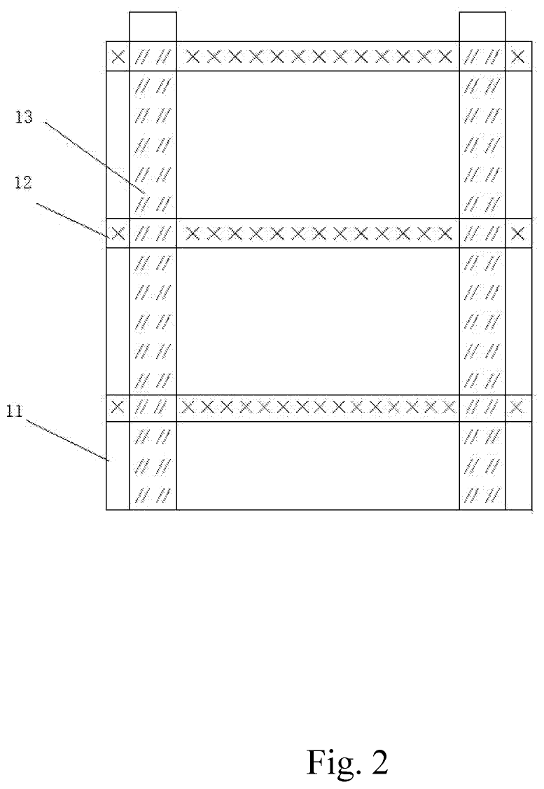

FIG. 3 is a schematic view of a first embodiment of the floor of the present application;

FIG. 4 is a schematic view of a second embodiment of the floor of the present application;

FIG. 5 is a schematic view of a third embodiment of the floor of the present application; and

FIG. 6 is a schematic view of a fourth embodiment of the floor of the present application.

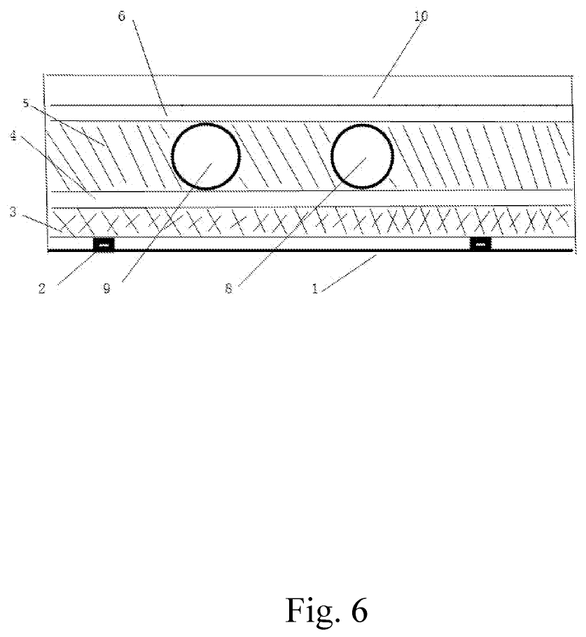

In the accompanying drawings: 1. floor iron sheet 2. square pipe 3. floor steel grating 4. lower impermeable membrane 5. rigid plastic foam 6. upper impermeable membrane 7. cement stone concrete 8. sewage pipe 9. drain pipe 10. colored cement talc layer 11. column iron sheet 12. column steel grating 13. steel post.

### DETAILED DESCRIPTION

The present application consists of floors and columns. Each of the floors is composed of a floor iron sheet 1, square pipes 2, a floor steel grating 3, a lower impermeable membrane 4, rigid plastic foam 5, an upper impermeable membrane 6 and cement stone concrete 7. Each of the columns is composed of a column iron sheet 11, column steel gratings 12, steel posts 13 and cement stone concrete. The floor iron sheet 1 is fixedly welded to the column iron sheet 11. The floor iron sheet 1 can completely seal the bottom of each floor. The column iron sheet 1 can completely wrap each column. An upper surface of the floor iron sheet 1 is welded to a lower part of each of the square pipes 2. The square pipes 2 perform a function of reinforcing the iron sheet 1, and the square pipes 2 are each provided with a thin pipe wall so that slotting and installation of electric wires beside the square pipes 2 are convenient. An upper part of each square pipe 2 is welded to the floor steel grating 3. The floor steel grating 3 is welded to the steel grating 12 and the steel posts 13 at an upper part of each column, and the floor iron sheet 1, the square pipes 2 and the steel grating 3 and the column iron sheets 11, the steel gratings 12 and the steel posts 13 are welded into a framework, which is firm and not prone to collapse. The columns and the bottom of the floors are cast with cement stone slurry for reinforcement. The lower impermeable membrane 4, the rigid plastic foam 5 and the upper impermeable membrane 6 are provided over the floor steel grating 3. The lower impermeable membrane 4, the rigid plastic foam 5 and the upper impermeable membrane 6 are sandwiched between the floor steel grating 3 and the cement stone concrete 7 for vibration isolation and acoustic and thermal insulation, which can prevent conduction of vibration, sound and heat between adjacent floors. The lower impermeable membrane 4 and the a upper impermeable membrane 6 have an anti-seepage function and can prevent sewage in pipelines in the plastic foam layer from leaking vertically. A drain pipe 9 from a hand washing basin, a dish washing basin, a bathroom, etc. and a sewage pipe 8 from a toilet are connected in parallel in the plastic foam layer and then joined to a main pipe, which is arranged in a pipeline groove beside the column. A gas pipe, a heating pipe, an air conditioner pipe, a water pipe and various cables extend separately from the main pipe in the pipeline groove beside the column, pass through the plastic foam layer and enter a user meter box. The pipes and cables are arranged in the plastic foam layer, and not concreted with the cement stone slurry, which is convenient for installation and maintenance. The upper impermeable membrane 6 can prevent the overlying cement slurry from flowing into the plastic foam layer. The cement stone concrete 7 is provided over the upper impermeable membrane 6. The cement stone concrete 7 is hard and can bear large loads. The surface of cement stone concrete 7 is treated separately.

Further, the cement stone concrete 7 is replaceable by cement volcanic scoria concrete according to actual situations, which cement volcanic scoria concrete is porous and lightweight, and can make the floors have better effects of vibration isolation and acoustic and thermal insulation.

Further, a colored cement talc layer 10 can be poured over the cement stone concrete 7, colored cement talc slurry is formed by mixing white cement, talc and water, in which a certain amount of pigment is added according, to specific situations, the colored cement talc slurry is poured to form the colored cement talc layer 10, the formed layer surface is flat, bright and visually pleasant because talc is delicate, lubricating and easy to level, and in addition, the talc is favorable for water permeation, so that the formed layer surface is sanitary and freshening.

Further, electric wires in a room under the floor extend separately from the meter box, run upwards through switches on walls to the bottom of the floor and extend between the floor iron sheet 1 and the steel grating 3, thereby avoiding the influence of the electric wires and dust over the electric wires on the room, and keeping a ceiling of the room visually pleasant, and during installation, only slotting, wire placing, sealing and welding, and filling at corresponding positions are needed, and local slotting results in a shallow depth, which does not affect the steel grating and the entire structure, and is convenient for installation and maintenance.

Further, a supporting plate is welded between each floor and each of the columns, and the supporting plate is a steel plate supported at the bottom of the floor, which is beneficial for load-bearing and construction and has an obvious effect especially for small columns and round columns.

Further, there is a pipeline groove beside the column, and there are various pipelines in the pipeline groove. The pipeline groove is installed in a recess of the column, which is visually pleasant, handy and convenient to install.

Further, the floor square pipes 2 above the columns can be replaced by a steel grating, so that there are two floor steel gratings above the columns, which can strengthen the floor around the columns, and make joints between the floors and the columns firmer.

Further, each floor is internally provided with cross members, vertical, steel gratings are arranged in each of the cross members, the vertical steel gratings being vertically welded to the floor steel grating 3, cement stone concrete is poured around the vertical steel grating, and the cross members within the floor can strengthen the floor.

Further, when the floor iron sheet 1 is thickened such that the floor iron sheet 1 can bear loads of the floor and objects on the floor, the square pipes 2 and the floor steel grating 3 may be omitted.

Further, when the column iron sheet 11 is thickened such that the column iron sheet 11 and the steel posts 13 can support the overlying part of the building, the column steel grating 12 may be omitted.

Further, when the column iron sheet 11 is thickened such that the column iron sheet 11 and the steel posts 13 can support the overlying part of the building, the column steel grating 12 and the cement stone concrete in the column are omitted.

Further, when the column iron sheet 11 is thickened, the column steel grating 12, the steel posts 13 and the cement stone concrete in the column are omitted.

Further, when the column iron sheet 11 is thickened such that the column iron sheet 11 can independently support the overlying part of the building, the column steel grating 12 and the steel posts 13 are omitted.

Further, according to specific actual situations, the lower impermeable membrane 4 may be omitted.

Further, according to specific actual situations, the upper impermeable membrane 6 may be omitted.

Further, according to specific actual situations, the rigid plastic foam 5 may be replaced by hollow bricks with the same acoustic and thermal insulation and vibration isolation functions.

Further, according to specific actual situations, the rigid plastic foam 5 may be replaced by a spaced supporting timber board layer with the same acoustic and thermal insulation and vibration isolation functions.

Further, if the floor panel is wooden floor, cement stone concrete 7 may be omitted according to actual situations.

Further, the present application further provides a floor and column structure, consisting of floors and columns, wherein the floor includes a floor iron sheet 1 and a layer for acoustic and thermal insulation and vibration isolation provided over the iron sheet, the layer for acoustic and thermal insulation and vibration isolation being rigid plastic foam 5, a hollow brick layer, or a spaced supporting timber board layer; and each of the columns includes a column iron sheet 11.

Optionally, in the floor and column structure, the floor further includes square pipes 2 provided over the floor iron sheet 1, and an upper surface of the floor iron sheet 1 is welded to a lower part of each of the square pipes 2.

Optionally, in the floor and column structure, each of the floors further includes a floor steel grating 3 provided over the square pipes 2, and an upper part of each square pipe 2 is welded to the floor steel grating 3.

Optionally, in the floor and column structure, each of the floors further includes a lower impermeable membrane 4 provided over the floor iron sheet 1.

Optionally, in, the floor and column structure, the lower impermeable membrane 4 is provided over the floor steel grating 3.

Optionally, in the floor and column structure, each of the floors further includes an upper impermeable membrane 6, and the upper impermeable membrane is provided over the layer for acoustic and thermal insulation and vibration isolation.

Optionally, in the floor and column structure, each of the floors further includes cement stone concrete 7, and the cement stone concrete 7 is provided over the upper impermeable membrane 6.

Optionally, in the floor and column structure,

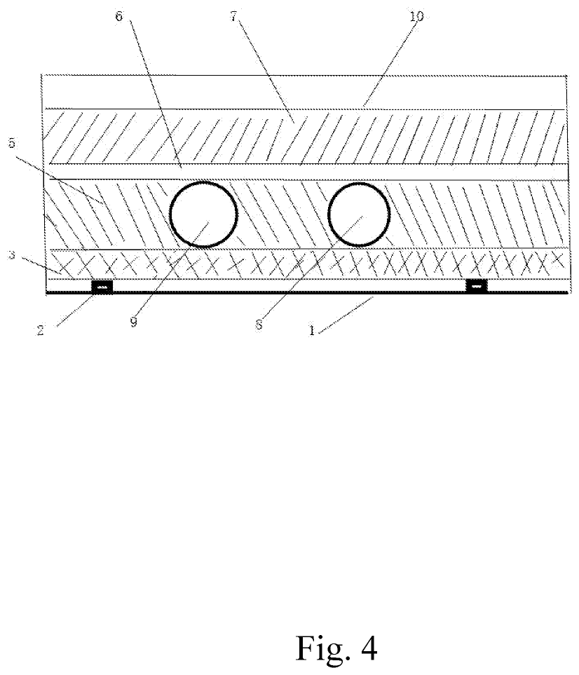

as shown in FIG. 4, each of the floors is composed of the floor iron sheet 1, square pipes 2, a floor steel grating 3, the layer for acoustic and thermal insulation and vibration isolation, an upper impermeable membrane 6 and cement stone concrete 7 arranged in sequence; or

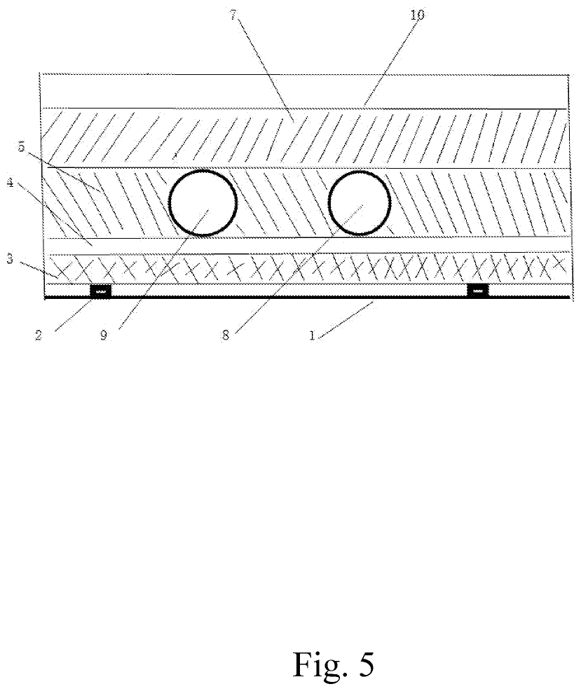

as shown in FIG. 5, the floor is composed of the floor iron sheet 1, square pipes 2, a floor steel grating 3, a lower impermeable membrane 4, the layer for acoustic and thermal insulation and vibration isolation and cement stone concrete 7 arranged, in sequence; or

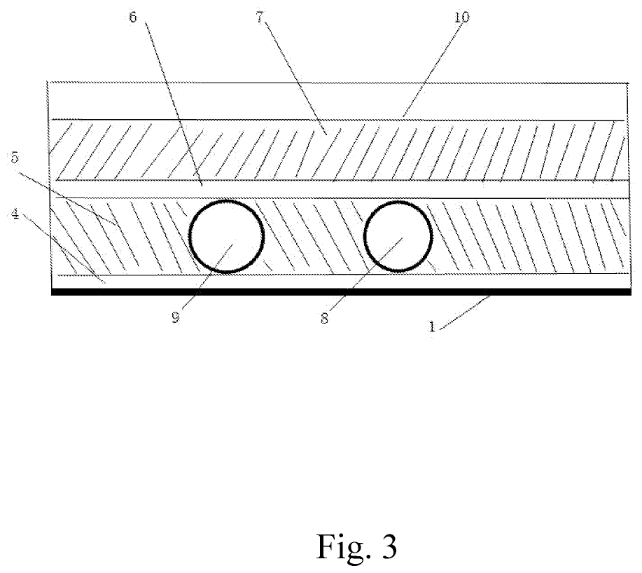

as shown in FIG. 3, when the floor iron sheet 1 is thickened such that the floor iron sheet 1 can bear loads of the floor and objects on the floor, the floor is composed of the floor iron sheet 1, a lower impermeable membrane 4, the layer for acoustic and thermal insulation and vibration isolation, an upper impermeable membrane 6 and cement stone concrete 7 arranged in sequence. In other implementations, the thickened iron sheet 1 which can bear the gravity of the floor and the objects on the floor can also be a hollow steel plate or an iron plate so as to facilitate welding and production. As long as the plate can bear the gravity of the floor and the objects on the floor, it will fall within the scope of the floor iron sheet 1 claimed in this application.

Optionally, in the floor and column structure, each of the columns further includes one or more of a column steel grating 12, a steel post 13 and cement stone concrete. Specifically, when the column iron sheet 11 is thickened such that the column iron sheet 11 and the steel posts 13 can support the overlying part of the building, the column includes the column iron sheet and the steel posts, and the column steel grating 12 and the cement stone concrete are omitted in the column. In other implementations, when the column iron sheet 11 is thickened, the column steel grating 12, the steel posts 13 and the cement stone concrete in the column may be omitted.

In order to facilitate welding and production in the implementation process, when the column iron sheet 11 needs to be thickened, a honeycomb hollow structure can be used, and its material can be steel, stainless steel, etc. The steel post 13 can be a honeycomb hollow metal column. Further, as required by interior decoration, a ceiling is formed under the floor iron sheet 1, some of electric wires, closed circuit television lines, network cables, telephone lines, heating pipes, cooling pipes, water pipes and gas pipes extend above the ceiling, and some of the electric wires, closed circuit television lines, network cables, telephone lines, heating pipes, cooling, pipes, water pipes, gas pipes and sewage pipes extend through the rigid plastic foam layer, namely, part of the electric wires, network cables, telephone lines, closed circuit television lines, heating pipes, cooling pipes, water pipes and gas pipes extend above the ceiling, and the rest of the electric wires, network cables, telephone lines, closed circuit television lines, heating pipes, cooling pipes, water pipes, gas pipes and sewage pipes extend through the rigid plastic foam layer.

The functions and connections of the floor iron sheet, square pipe, floor steel grating, lower impermeable membrane, upper impermeable membrane, cement stone concrete, column iron sheet, column steel grating, steel post and concrete involved in the floor and column structure of the present application are the same as those of corresponding structural components in the technical scheme of the floors and columns of the present application. The layer for acoustic and thermal insulation and vibration isolation is the rigid plastic foam layer 5, and in other embodiments, alternatively, may be a hollow brick layer, or a spaced supporting timber board layer. In the embodiments shown in FIGS. 3, 4 and 5, the colored cement talc layer 10 may be further provided over the cement stone concrete 7, and a sewage pipe 8 and a drain pipe 9 are arranged in the layer for acoustic and thermal insulation and vibration isolation.

1. A floor and column structure, consisting of floors and columns, wherein each of the floors is composed of a floor iron sheet (1), square pipes (2), a floor steel grating (3), a lower impermeable membrane (4), rigid plastic foam (5), an upper impermeable membrane (6) and cement stone concrete (7); each of the columns is composed of a column iron sheet (11), column steel gratings (12), steel posts (13) and cement stone concrete; the floor iron sheet (1) is fixedly welded to the column iron sheet (11); the floor iron sheet (1) can completely seal the bottom of each floor; the column iron sheet (11) can completely wrap each column; an upper surface of the floor iron sheet (1) is welded to a lower part of each of the square pipes (2); the square pipes (2) perform a function of reinforcing the iron sheet (1), and the square pipes (2) are each provided with a thin pipe wall so that slotting and installation of electric wires beside the square pipes (2) are convenient; an upper part of each square pipe (2) is welded to the floor steel grating (3); the floor steel grating (3) is welded to the steel grating (12) and the steel posts (13) at an upper part of, each column, and the floor iron sheet (1), the square pipes (2) and the steel grating (3) and the column iron sheets (11), the steel gratings (12) and the steel posts (13) are welded into a framework, which is firm and not prone to collapse; the columns and the bottom of the floors are cast with cement stone slurry for reinforcement; the lower impermeable membrane (4), the rigid plastic foam (5) and the upper impermeable membrane (6) are provided over the floor steel grating (3); the lower impermeable membrane (4), the rigid plastic foam (5) and the upper impermeable membrane (6) are sandwiched between the floor steel grating (3) and the cement stone concrete (7) for vibration isolation and acoustic and thermal insulation, which can prevent conduction of vibration, sound and heat between adjacent floors; the lower impermeable membrane (4) and the upper impermeable membrane (6) have an anti-seepage function and can prevent sewage in pipelines in the plastic foam layer from leaking vertically; a drain pipe (9) from a hand washing basin, a dish washing basin, a bathroom, etc. and a sewage pipe (8) from a toilet are connected in parallel in the plastic foam layer and then joined to a main pipe, which is arranged in a pipeline groove beside the column; a gas pipe, a heating pipe, an air conditioner pipe, a water pipe and various cables extend separately from the main pipe in the pipeline groove beside the column, pass through the plastic foam layer and enter a user meter box; the pipes and cables are arranged in the plastic foam layer, and not concreted with the cement stone slurry, which is convenient for installation and maintenance; the upper impermeable membrane (6) can prevent the overlying cement slurry from flowing into the plastic foam layer; the cement stone concrete (7) is provided over the upper impermeable membrane (6); the cement stone concrete (7) is hard and can bear large loads; and the surface of cement stone concrete (7) is treated separately.

2. The floor and column structure of claim 1, wherein, the cement stone concrete (7) is replaceable by cement volcanic scoria concrete according to actual situations, which cement volcanic scoria concrete is porous and lightweight, and can make the floors have better effects of vibration isolation and acoustic and thermal insulation.

3. The floor and column structure of claim 1, wherein a colored cement talc layer (10) can, be poured over the cement stone concrete (7), colored cement talc slurry is formed by mixing white cement, talc and water, in which a certain amount of pigment is added according to specific situations, the colored cement talc slurry is poured to form the colored cement talc layer (10), the formed layer surface is flat, bright and visually pleasant because talc is delicate, lubricating and easy to level, and in addition, the talc is favorable for water permeation, so that the formed layer surface is sanitary and freshening.

4. The floor and column structure of claim 1, wherein electric wires in a room under the floor extend separately from the meter box, run upwards through switches on walls to the bottom of the floor and extend between the floor iron sheet (1) and the steel grating (3), thereby avoiding the influence of the electric wires and dust over the electric wires on the room, and keeping a ceiling of the room visually pleasant, and during installation, only slotting, wire placing, sealing and, welding, and filling at corresponding positions are needed, and local slotting results in a shallow depth, which does not affect the steel grating and the entire structure, and is convenient for installation and maintenance.

5. The floor and column structure of claim 1, wherein a supporting plate is welded between each floor and each of the columns, and the supporting plate is a steel plate supported at the bottom of the floor, which is beneficial for load-bearing and construction and has an obvious effect especially for small columns and round columns.

6. The floor and column structure of claim 1, wherein the floor square pipes (2) above the columns can be replaced by a steel grating, so that there are two floor steel gratings above the columns, which can strengthen the floor around the columns and make joints between the floors and the columns firmer.

7. The floor and column structure of claim 1, wherein each floor is internally provided with cross members, vertical steel gratings are arranged in each of the cross members, the vertical steel gratings being vertically welded to the floor steel grating (3), cement stone concrete is poured around the vertical steel grating, and the cross members within the floor can strengthen the floor.

8. The floor and column structure of claim 1, wherein both the floor iron sheet (1) and the column iron sheet (11) are of a hollow structure.

9. The floor and column structure of claim 8, wherein the column iron sheet (11) is of a honeycomb hollow structure.

10. A floor and column structure, consisting of floors and columns, wherein the floor comprises a floor iron sheet (1) and a layer for acoustic and thermal insulation and vibration isolation provided over the iron sheet, the layer for acoustic and thermal insulation and vibration isolation being rigid plastic foam (5), a hollow brick layer, or a spaced supporting timber board layer; and each of the columns comprises a column iron sheet (11).

11. The floor and column structure of claim 10, wherein the floor further comprises square pipes (2) provided over the floor iron sheet (1), and an upper surface of the floor iron sheet (1) is welded to a lower part of each of the square pipes (2).

12. The floor and column structure of claim 10, wherein each of the floors further comprises a floor steel grating (3) provided over the square pipes (2), and an upper part of each square pipe (2) is welded to the floor steel grating (3).

13. The floor and column structure of claim 10, wherein each of the floors further comprises a lower impermeable membrane (4) provided over the floor iron sheet (1).

14. The floor and column structure of claim 12, wherein the lower impermeable membrane (4) is provided over the floor steel grating (3).

15. The floor and column structure of claim 10, wherein each of the floors further comprises an upper impermeable membrane (6), and the upper impermeable membrane is provided over the layer for acoustic and thermal insulation and vibration isolation.

16. The floor and column structure of claim 10, wherein each of the floors further comprises cement stone concrete (7), and the cement stone concrete (7) is provided over the upper impermeable membrane (6).

17. The floor and column structure of claim 10, wherein
each of the floors is composed of the floor iron sheet (1), square pipes (2), a floor steel grating (3), the layer for acoustic and thermal insulation and vibration isolation, an upper impermeable membrane (6) and cement stone concrete (7) arranged in sequence; or
the floor is composed of the floor iron sheet (1), square pipes (2), a floor steel grating (3), a lower impermeable membrane (4), the layer for acoustic and thermal insulation and vibration isolation and cement stone concrete (7) arranged in sequence; or
when the floor iron sheet (1) is thickened such that the floor iron sheet (1) can bear loads of the floor and objects on the floor, the floor is composed of the floor iron sheet (1), a lower impermeable membrane (4), the layer for acoustic and thermal insulation and vibration isolation, an upper impermeable membrane (6) and cement stone concrete (7) arranged in sequence.

18. The floor and column structure of claim 10, wherein each of the columns further comprises one or more of a column steel grating (12), a steel post (13) and cement stone concrete.

19. The floor and column structure of claim 10, wherein a ceiling is formed under the floor iron sheet (1), at least part of electric wires, closed circuit television lines, network cables, telephone lines, heating pipes, cooling pipes, water pipes and gas pipes extend above the ceiling, and at least part of the electric wires, closed circuit television lines, network cables, telephone lines, heating pipes, cooling pipes, water pipes, gas pipes and sewage pipes extend through the layer for acoustic and thermal insulation and vibration isolation, the layer for acoustic and thermal insulation and vibration isolation being rigid plastic foam (5), a hollow brick layer, or a spaced supporting timber board layer.

20. The floor and column structure of claim 10, wherein both the floor iron sheet (1) and the column iron sheet (11) are of a hollow structure.
